(19) United States
(12) Patent Application Publication
(10) Pub. No.: US 2026/0075007 A1
(43) Pub. Date: Mar. 12, 2026

(54) TASK MANAGEMENT AND ROUTING IN A MULTI-CHANNEL ENVIRONMENT

(71) Applicant: Capital One Services, LLC, McLean, VA (US)

(72) Inventors: Trent F. HODGES, Richmond, VA (US); Kimberly Diane WILCOX, Henrico, VA (US); Leigh KESLER, Midlothian, VA (US); Christopher Joseph LEADBETTER, Glen Allen, VA (US); Caelinn COMEY, Richmond, VA (US); Noah MANDELBAUM, Mechanicsville, VA (US); Subbu THIRUPPATHY, Henrico, VA (US); Rodney C. BAKER, Goochland, VA (US); William J. FARMER, II, New York, NY (US); Vincent PELLETIER, Richmond, VA (US); Jennifer Crowther GOPALAKRISHNAN, Glen Allen, VA (US); Leah GONZALEZ HOWARD, Arlington, VA (US); Grace THORNTON, Richmond, VA (US); Jeremy WEST, Allen, TX (US); Andre BIERZYNSKI, Alexandria, VA (US); Alana Brooke CHOUEKA, New York, NY (US)

(21) Appl. No.: 18/830,905

(22) Filed: Sep. 11, 2024

(51) Int. Cl. H04L 47/50; H04L 43/08

(52) U.S. Cl. CPC H04L 47/50; H04L 43/08

(57) ABSTRACT

In some implementations, a device may obtain one or more routing profiles associated with respective agents of a contact center network. The device may obtain a task associated with a task type and one or more task attributes. The device may determine an order of tasks that includes the task. The device may determine an agent channel for the task based on the task type, one or more network conditions, and the one or more routing profiles, wherein the agent channel is associated with a routing profile, of the one or more routing profiles, based on current task load information of the routing profile and the one or more task attributes. The device may route the task to the agent channel. The device may provide information associated with the task to a user interface system to enable an agent, associated with the routing profile, to perform the task.

### BACKGROUND

“Network routing” refers to the process of directing data packets or tasks from a source to a destination across a network infrastructure. Network routing may rely on one or more algorithms and/or protocols to determine an optimal path based on one or more factors, such as traffic load, network topology, and/or cost metrics, among other examples. “Task management” refers to the allocation of computing resources and/or the scheduling of tasks across networked devices to ensure optimal performance and utilization. The task management may be facilitated by technologies, such as load balancers and/or job schedulers, among other examples. Network routing and task management may enable a network to maintain the reliability, efficiency, and/or scalability of one or more systems.

### SUMMARY

In some implementations, a system for task management and routing for a contact center network includes a dynamic routing profile component, configured to: obtain one or more routing rules associated with one or more routing profiles, wherein the one or more routing profiles are associated with respective agents; determine, based on dynamic network activity of the contact center network and the one or more routing rules, routing profile information for respective routing profiles of the one or more routing profiles; and provide, to a network routing management component, the routing profile information; the network routing management component, configured to: obtain an indication of one or more network conditions associated with the contact center network; obtain an indication of a task associated with the contact center network, wherein the task is associated with a task type and one or more task attributes; assign, for the task, a position in a network queue, wherein the position is based on one or more rules and the one or more network conditions, and wherein the network queue includes tasks associated with multiple task types; select, for the task, an agent channel that is associated with an agent of the contact center network based on the routing profile information, the task type, and the one or more task attributes; and transfer, from the network queue, the task to the agent channel.

In some implementations, a method for task management and routing includes obtaining, by a device, one or more routing profiles associated with respective agents of a contact center network; obtaining, by the device, a task associated with a task type and one or more task attributes; determining, by the device in accordance with a rule set, an order of tasks that includes the task, wherein the rule set includes one or more intra-task-type rules associated with the task type and one or more inter-task-type rules associated with multiple task channels; determining, by the device in accordance with the order of tasks, an agent channel for the task based on the task type, one or more network conditions, and the one or more routing profiles, wherein the agent channel is associated with a routing profile, of the one or more routing profiles, based on current task load information of the routing profile and the one or more task attributes; routing, by the device, the task to the agent channel; and providing, by the device and based on routing the task to the agent channel, information associated with the task to a user interface system to enable an agent, associated with the routing profile, to perform the task.

In some implementations, a system for task management and routing includes one or more memories; and one or more processors, communicatively coupled to the one or more memories, configured to: obtain one or more routing rules associated with one or more routing profiles, wherein the one or more routing profiles are associated with respective agents; determine, based on dynamic network activity of a contact center network and the one or more routing rules, routing profile information for respective routing profiles of the one or more routing profiles; and obtain an indication of a task associated with the contact center network, wherein the task is associated with a task type and one or more task attributes; assign, for the task, a position in a network queue, wherein the position is based on one or more rules and one or more network conditions, and wherein the network queue includes tasks associated with multiple task types; select, for the task, an agent channel that is associated with an agent of the contact center network based on the routing profile information, the task type, and the one or more task attributes; transfer, from the network queue, the task to the agent channel; and provide, from the agent channel, information indicative of the task for display via a user interface system.

### BRIEF DESCRIPTION OF THE DRAWINGS

FIGS. 1A-1C are diagrams of an example associated with task management and routing in a multi-channel environment, in accordance with some embodiments of the present disclosure.

FIG. 2 is a diagram of an example associated with task management and routing in a multi-channel environment, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with task management and routing in a multi-channel environment, in accordance with some embodiments of the present disclosure.

FIG. 5 is a flowchart of an example process associated with task management and routing in a multi-channel environment, in accordance with some embodiments of the present disclosure.

### DETAILED DESCRIPTION

The following detailed description of example implementations refers to the accompanying drawings. The same reference numbers in different drawings may identify the same or similar elements.

A contact center (e.g., a call center, a chat interface, and/or a customer contact center) may be equipped to handle customer communications, such as telephone communications, e-mail, messages, and/or live chat communications, among other examples. The contact center may route such communications to appropriate employees (e.g., service representatives or agents) and/or platforms associated with an entity, in order to provide a customer service or receive and/or respond to customer feedback regarding services provided by the entity. A contact center allows users or individuals to communicate and/or engage with agents of an entity associated with the contact center. The users may be consumers or customers that are seeking assistance with, or information associated with, a product or service that is offered by the entity. The agents may provide the assistance or information via voice calls or other communication channels that are managed by the contact center (e.g., via a management system that hosts communications between the users and the agents).

A customer that initiates a communication with a contact center for a specific purpose (e.g., fraud reporting) may be placed in a queue with other waiting customers. When an agent at the contact center becomes available, the customer that is waiting in the queue may be matched with an available agent. The available agent may be qualified to handle communications on that queue. After being added to queues, customers may be matched with available agents on a first-come, first-served basis, such that a customer that has been waiting the longest period of time on that queue, as compared to other customers on that queue, may be first in line to be matched with the next available agent.

A contact center system may provide an omnichannel contact center (e.g., in a multi-channel environment). As used herein, “channel” may refer to a communication channel or a task channel. “Communication channel” refers to a medium through which information is transmitted between a sender (e.g., a customer) and a receiver (e.g., an agent). Example communication channels may include a call channel (e.g., a phone call channel), a text message channel, a chat channel, a video chat channel, a mail channel (e.g., physical mail), and/or an email channel, among other examples. “Task channel” refers to an operational pathway used by an agent to perform or manage tasks assigned to, or otherwise performable by, the agent.

The contact center system may establish communications over multiple channels (e.g., voice, video, and/or chat) between customers and agents. The contact center system may receive an indication of a communication initiated by a customer, and add the customer to a queue. When an agent is available to perform a task, the contact center system may indicate to the agent to select or “pull” a task from the queue. The contact center system may route a customer communication to the available agent, such that an electronic communication may be established to involve the customer and the agent. The contact center system may implement a series of rules for classifying customers and adding the customers to queues, before the customers are matched with available agents. The rules may involve directing an electronic communication initiated by a customer to an appropriate queue based on an objective associated with the electronic communication (e.g., fraud reporting), and then identifying an agent associated with that queue and that is available to be associated with the communication to aid the customer. For example, the contact center system may route or match available agents to a task, such as a customer communication in a queue. The rules may be defined by a client (e.g., a financial services company) of the contact center system that is using the contact center system to provide customer services to customers of the client.

The client may wish to update the rules and/or attributes for identifying queues and routing communications to available agents. For example, the client may wish to modify a rule that redirects a customer from a first queue to a second queue when a number of customers that are currently waiting in the first queue satisfies a threshold. The rule may specify a maximum queue limit, at which point customers may be routed to an alternate queue. As another example, a queue may have attributes indicating that the queue is related to fraud reporting for Spanish speakers, and the client may wish to split the queue into a first queue and a second queue. The first queue may have attributes indicating that the first queue is related to fraud reporting for high-value Spanish speakers, and the second queue may have attributes indicating that the second queue is related to fraud reporting for normal-value Spanish speakers.

When the rules and/or attributes for identifying the queues and routing the electronic communications to the available agents are being updated, an interface provided by the contact center system may be accessed by the client. The interface may provide the client with a mechanism to input updated rules and/or attributes associated with a plurality of possible queues. However, such rules and/or attributes may be hard-coded in the contact center system, and updating the rules and/or attributes may be a time-consuming process and may involve manually replicating updates across different regions. Such updates may need to be performed after-hours (e.g., after 10 PM locally) to minimize a downtime impact to customers. Production changes involving a relatively large update to existing rules and/or attributes may take a relatively large amount of time and manpower due to the rigidity of the contact center system.

Additionally, the contact center system may route tasks or work using an agent-to-work approach (e.g., in which agents are assigned work from the queue(s)). This results in an inefficient task management operation for the contact center. For example, the contact center system may use a task management operation that only considers factors or information associated with a communication or task. As a result, the contact center system may route a communication or task to an agent that may be available, but may be experiencing other conditions that reduce the efficiency of performing the task or may otherwise degrade the performance of the task. This consumes network resources, processing resources, and/or computing resources, among other examples, associated with routing and performing the task(s) inefficiently. Moreover, the contact center system may categorize and queue tasks in accordance with factors or information associated with the tasks. However, after the task(s) are queued in separate queues, the contact center system may be unable to prioritize or manage tasks having different task types or tasks that are queued in the separate queues. This results in inefficient task management and network resource utilization for the contact center system.

Some implementations described herein enable task management and routing in a multi-channel environment, such as a contact center environment. In some implementations, a system may include one or more components configured to prioritize and route one or more tasks for the multi-channel environment to a given agent. The system may select the agent based on one or more rules (e.g., routing rules), a routing profile of the agent, one or more attributes of the task, and/or one or more network conditions associated with a contact center network, among other examples.

For example, the system may include a dynamic routing profile component that is configured to determine, based on dynamic network activity of the contact center network and one or more routing rules, routing profile information for respective routing profiles. A routing profile may be associated with an agent of the contact center. The routing profile information may indicate real-time information for a workload of the agent and/or may be dynamically updated as the agent performs one or more tasks over time. The system may include a network routing management component that is configured to prioritize tasks within a given task type and across multiple task types (e.g., the network routing management component may be configured to perform prioritization using inter-task-type prioritization rules and intra-task-type prioritization rules). For example, the network routing management component may be configured to assign, for a task, a position in a network queue, where the position is based on one or more rules (e.g., prioritization rule(s)) and one or more network conditions. The network routing management component may be configured to select, for the task, an agent channel that is associated with an agent of the contact center network based on the routing profile information, the task type, and the one or more task attributes. The agent channel may be associated with a given agent. The network routing management component may be configured to transfer, from the network queue, the task to the agent channel. The system may include an agent console configured to provide, from the agent channel, information indicative of the task for display via a user interface system.

In some implementations, the routing profile information may indicate that a given routing profile is associated with a task load score that is indicative of a workload or amount of work that an agent (e.g., that is associated with the given routing profile) has recently performed. The network routing management component may be configured to select the agent to perform the task based on determining that the one or more task attributes indicate that the task load score for the routing profile will not satisfy a threshold if the task is assigned or performed by the agent. In some implementations, the network routing management component may be configured to assign a work break task (e.g., a task that indicates that the agent is to take a break from performing work) to an agent based on the task load score of the routing profile.

In some implementations, a routing profile may be associated with indicating a cognitive switching limit indicative of one or more permissible task types (or a quantity of task types that can be assigned or a sequence of tasks types that can be assigned) for an agent channel associated with the routing profile. In such examples, the network routing management component may be configured to select the agent channel based on the task type being included in the one or more permissible task types.

As a result, the system may enable tasks in a multi-channel environment to be routed to an agent in an optimized manner and at optimized times by using considerations such as the routing profile information, the network condition(s), and/or the inter-task-type and intra-task-type prioritization, among other examples. This enables the system to improve contact center network resource utilization by ensuring that a task is routed to an agent that can perform the task in an optimized manner at the time that the task is routed to the agent channel. This conserves processing resources, network resources, and/or computing resources that would otherwise be used to route a task to an agent that is available and capable of performing the task but may perform the task in a sub-optimal manner (e.g., because of being overworked, as indicated by the task load score of the routing profile, and/or because of performing multiple cognitive switches between different tasks of multiple task types, which reduces the efficiency of performing the task). For example, the system may use the routing profile information, the network condition(s), task prioritization information, and task attributes to route an optimized type of task to an agent at an optimized time, thereby improving a performance level of the task(s) and/or improving contact center network resource utilization. This improves the network resource utilization for the contact center network by improving the likelihood of a task being routed to a given agent in an optimized manner for both network performance and agent performance.

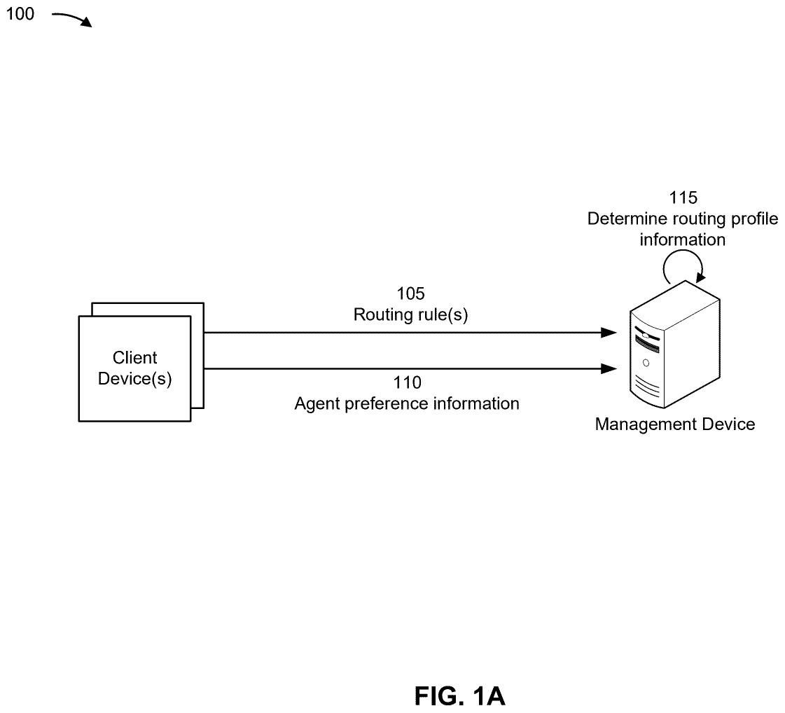

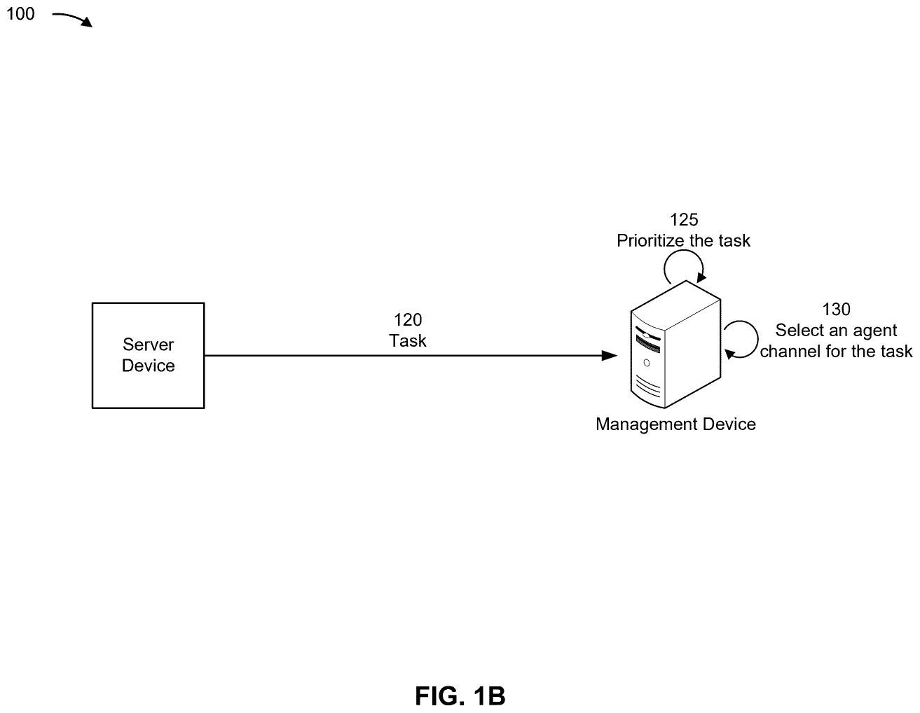

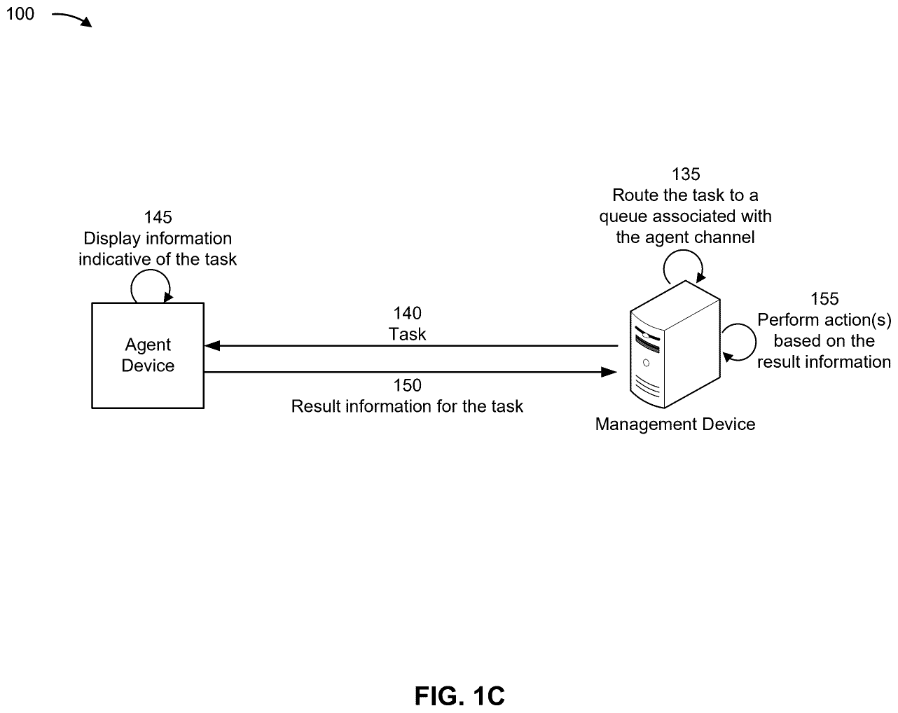

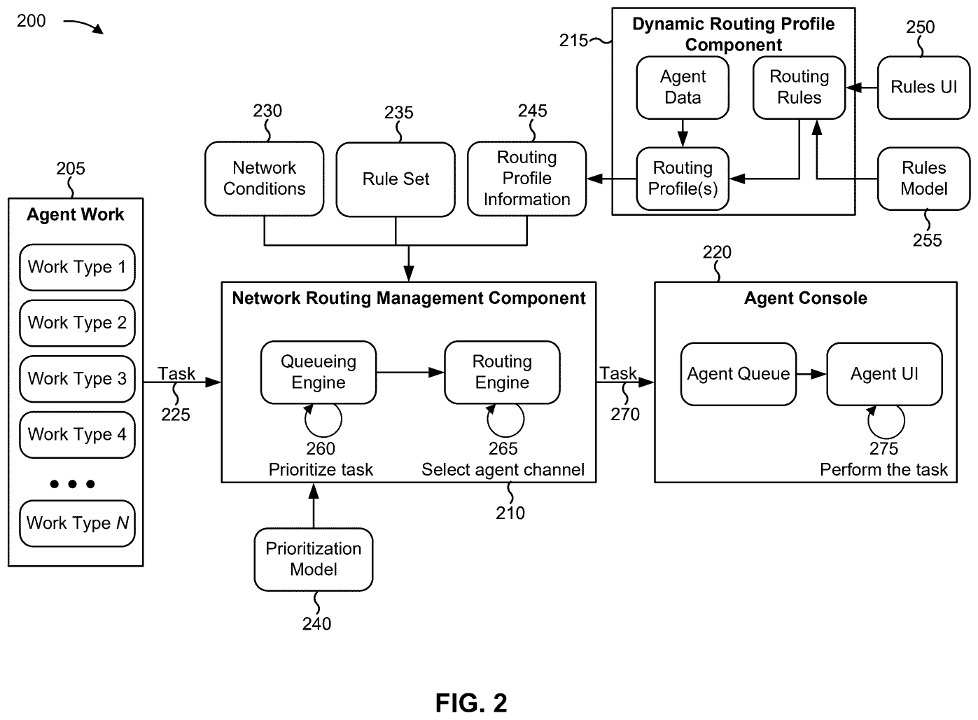

FIGS. 1A-1C are diagrams of an example 100 associated with task management and routing in a multi-channel environment. As shown in FIGS. 1A-1C, example 100 includes a management device, one or more client devices, a server device, and an agent device. These devices are described in more detail in connection with FIGS. 2, 3, and 4. The management device may be, or may be included in, a system configured to perform task management and routing in a multi-channel environment, such as the system depicted and described in connection with FIG. 2.

As shown in FIG. 1A, the management device may obtain one or more routing rules. A routing rule may indicate information (e.g., criteria and/or conditions) indicative of how and/or when a task is to be routed or directed to a given agent or queue. For example, a routing rule may be associated with one or more parameters, such as one or more agent capability parameters (e.g., indicative of capabilities of a given agent), a work load parameter (e.g., a task load score), a cognitive switching parameter (e.g., a cognitive switching limit), one or more agent preference parameters (e.g., indicating preferences or settings of a given agent), and/or one or more prioritization parameters (e.g., prioritizing certain task types or tasks within a given task type), among other examples. In some implementations, as shown by reference number 105, a client device may provide or transmit, and the management device may obtain or receive, an indication of one or more routing rules.

The one or more routing rules may be associated with one or more routing profiles. The one or more routing profiles may be associated with respective agents. For example, a routing profile may include information indicative of how, when, or if one or more tasks are to be routed to an agent associated with the routing profile (e.g., to an agent channel or queue associated with the agent). As used herein, “agent” refers to an employee or user who performs tasks associated with a contact center.

In some implementations, the client device may obtain information indicative of the one or more routing rules via a user input, such as via a user interface displayed by the client device. For example, the management device may provide or manage a user interface that enables a user to input information indicative of the one or more routing rules. The client device may display the user interface. A user may provide one or more inputs to the user interface that are indicative of the one or more routing rules. This enables users who have more knowledge of, or exposure to, performance levels or performance evaluation of tasks associated with the contact center to define the routing rule(s) without needing knowledge of, or expertise in, complex network routing protocols.

As shown by reference number 110, the management device may obtain agent preference information. In some implementations, as shown in FIG. 1A, a client device may provide or transmit, and the management device may obtain or receive, the agent preference information. Additionally, or alternatively, the management device may obtain the agent preference information from memory or from another device or system. The agent preference information may be indicative of one or more preferences of respective agents associated with the contact center. For example, the agent preference information may indicate one or more task types that a given agent prefers to perform. As another example, the agent preference information may indicate a preferred cognitive switching limit of a given agent (e.g., indicating a quantity of task types that an agent prefers to perform over a given time interval, such as a working day). The agent preference information may indicate working time preferences, such as a preferred work schedule (e.g., indicating days and/or times during which the agent prefers to perform tasks), and/or a preferred break schedule (e.g., indicating times at which the agent prefers to take a break from performing tasks), among other examples.

As shown by reference number 115, the management device may determine routing profile information. The management device may determine routing profile information for respective routing profiles of agents associated with the contact center. The routing profile information may indicate one or more dynamic routing rules for a given routing profile. The one or more dynamic routing rules may be based on the routing rule(s) obtained by the management device (e.g., as described in connection with reference number 105), dynamic network activity of a contact center network, agent preference information of an agent associated with the routing profile, and/or other information associated with the agent, among other examples. The dynamic network activity may be indicative of traffic or tasks being performed (or previously performed) for the contact center.

In some implementations, the dynamic network activity may indicate information associated with the contact center network as a whole (e.g., may be traffic or tasks associated with multiple channels and/or multiple agents). Additionally, or alternatively, the dynamic network activity may indicate information associated with the agent and/or the routing profile. For example, the dynamic network activity may indicate one or more previous tasks performed by the agent. Additionally, or alternatively, the dynamic network activity may indicate a task load score for the agent and/or the routing profile. The task load score may be indicative of an amount of work performed by the agent, a difficulty level of the work being performed by the agent, and/or another metric associated with task(s) previously performed by the agent. The task load score may be associated with a time interval, such as X minutes or hours. In such examples, the task load score may be indicative of one or more metrics (e.g., an amount, a level, a complexity, and/or a difficulty) associated with task(s) previously performed by the agent within the last X minutes or hours. In some aspects, the task load score may be updated or calculated after each task performed by the agent. For example, the management device may determine the task load score for a routing profile or for an agent based on obtaining an indication of a completed task associated with the routing profile or associated with the agent. This enables the management device to improve a likelihood of tasks being performed more efficiently and/or at a higher level, because the management device can selectively route tasks to an agent based on the difficulty and/or complexity of the task and the task load score associated with the agent (e.g., reducing the likelihood that an overworked agent is assigned a difficult or complex task).

The management device may modify or adjust one or more routing rules (e.g., obtained by the management device as described in connection with reference number 105) for a routing profile based on the dynamic network activity. For example, if the dynamic network activity indicates that a given task type is occurring more frequently within the contact center network, then the management device may modify or adjust the one or more routing rules to cause the given task type to be routed to the agent more often (e.g., may prioritize the given task type). As another example, if the dynamic network activity indicates that the agent is overworked (e.g., if the task load score for the routing profile satisfies a threshold), then the management device may modify or adjust the one or more routing rules to cause easier-to-perform or less-complex tasks (e.g., tasks having task attributes indicative of a lower level of complexity or difficulty and/or a work break task) to be routed to the agent more often.

The management device may modify or adjust one or more routing rules (e.g., obtained by the management device as described in connection with reference number 105) for a routing profile based on agent preference information of the agent associated with the routing profile. For example, if the agent preference information indicates one or more preferred task types, then the management device may modify or adjust one or more routing rules to cause tasks having the preferred task type(s) to be routed to the agent more often. As another example, if the agent preference information indicates a work schedule, then the management device may modify or adjust one or more routing rules to cause tasks to be routed to the agent during working times of the agent and to cause tasks to not be routed to the agent during non-working times (e.g., as indicated by the work schedule).

In some implementations, the management device may determine the routing profile information via a machine learning model. The machine learning model may be a routing and/or rule optimization model. For example, the management device may provide one or more inputs to the routing and/or rule optimization model. For example, the one or more inputs may include the routing rule(s) obtained by the management device (e.g., as described in connection with reference number 105), the dynamic network activity of a contact center network, agent preference information of an agent associated with the routing profile, and/or other information associated with the agent, among other examples. The routing and/or rule optimization model may be configured or trained to output the routing profile information. For example, the routing and/or rule optimization model may be configured or trained to output dynamic routing rule(s) for a routing profile.

The management device may improve the usefulness and/or accuracy of the output of the routing and/or rule optimization model by providing the routing rule(s) obtained by the management device (e.g., as described in connection with reference number 105), the dynamic network activity of a contact center network, and the agent preference information as input(s) to the routing and/or rule optimization model. For example, the considerations and factors indicated by the input(s) enable the routing and/or rule optimization model to determine or calculate dynamic routing rule(s) for a routing profile that improve the timing, type, and/or difficulty of tasks routed to a given agent. This improves the network resource utilization for the contact center network by improving the likelihood of a task being routed to a given agent in an optimized manner for both network performance and agent performance.

As shown in FIG. 1B, the management device may obtain an indication of a task associated with the contact center. In some implementations, as shown in FIG. 1B, the management device may obtain the indication of the task via the server device. The task may be associated with a task type. For example, the task type may be an inbound communication, an outbound communication, a call, a chat, an email, a live chat, a video chat, a training task, an internal case management task, a machine learning task, and/or a work break, among other examples. The task may be associated with one or more task attributes. A task attribute may indicate a characteristic or metric associated with the task. For example, a task attribute may be indicative of a reason for or source of the task, a category of the task (e.g., for an inbound call, a category may include a fraud call, a transfer request, or another category), a classification of the task, a difficulty of the task, a complexity of the task, and/or an estimated amount of time to complete the task, among other examples.

As shown by reference number 125, the management device may prioritize the task. For example, the management device may queue the task within a network queue. The management device may assign, for the task, a position in the network queue. The network queue may include tasks associated with multiple task types. For example, the management device may determine an order of tasks that includes the task (e.g., where the tasks are ordered in the network queue). In some implementations, the contact center network may be associated with a single queue for prioritizing and/or ordering all tasks to be performed by agents of the contact center. For example, the network queue may be a queue from which the management device obtains tasks to assign or route to an agent channel, as described in more detail herein. By the management device prioritizing tasks within the network queue, the management device may ensure that higher priority tasks are routed to agents before lower priority tasks.

The position assigned to the task within the network queue may be based on one or more rules and one or more network conditions. The one or more rules may be prioritization rules. A prioritization rule may indicate information, characteristics, conditions, or metrics to be used to prioritize among multiple tasks. The one or more rules may include one or more intra-task-type rules associated with a given task type and one or more inter-task-type rules associated with the multiple task types. For example, the management device may prioritize tasks associated with the same task type (e.g., using one or more intra-task-type rules for that task type). Additionally, the management device may prioritize tasks associated with the different task types (e.g., using one or more inter-task-type rules). This enables the management device to prioritize and/or order tasks having different task types within the same network queue. By using the single network queue, the complexity associated with prioritizing and routing tasks having different task types may be reduced.

For example, the one or more network conditions may indicate a relative frequency of different task types (e.g., indicating which task types are currently occurring more or less frequently) occurring across the contact center network. The management device may queue tasks associated with task types that are occurring more frequently before tasks associated with task types that are occurring less frequently (e.g., as indicated by the one or more network conditions). As another example, a task attribute may indicate an importance level of a task. The management device may queue tasks associated with higher importance levels before tasks associated with lower importance levels. This improves the likelihood that more important or critical tasks are performed earlier (e.g., because these tasks are queued before less important tasks in the network queue).

As another example, the one or more network conditions may indicate whether the contact center is experiencing an agent surplus or a communication surplus. For example, if the contact center may be receiving fewer communications than expected, this may be indicative of an agent surplus (e.g., because there may be more agents working than are needed to handle the quantity of communications being received for the contact center). As another example, if the contact center may be receiving more communications than expected, this may be indicative of a communication surplus (e.g., because there may more communications than the quantity of agents currently working can handle). As described herein, the management device may queue or route tasks based on the one or more network conditions. For example, if the one or more network conditions indicate an agent surplus, then this may be indicative of having idle agents (e.g., agents that are not handling any communications for the contact center). In such examples, the management device may route non-communication-based tasks (e.g., service tasks, non-user-facing tasks, and/or machine learning tasks) to the idle agent(s) to improve the efficiency of task performance for the contact center network. As another example, if the one or more network conditions indicate a communication surplus, then the management device may prioritize (e.g., temporarily until the network condition(s) no longer indicate a communication surplus) communication tasks (or a certain type of communication task if the network condition(s) indicate that the communications being received are primarily that type of communication task). This may enable agents that may have otherwise been performing non-communication-based tasks for the contact center to be routed communication-based tasks to facilitate handling the communication surplus.

As shown by reference number 130, the management device may select or determine an agent channel for the task. The management device may select or determine the agent channel based on obtaining the task from the network queue (e.g., in accordance with ordering and/or prioritization within the network queue). For example, the management device may select the agent channel for the task based on determining that the task is the next task to be routed from the network queue. The agent channel may be associated with a routing profile. For example, the management device may select or determine an agent to perform the task by selecting or determining the agent channel.

The management device may select or determine the agent channel for the task based on the task type, one or more network conditions, the routing profile information, and/or one or more task attributes of the task. For example, the management device may identify one or more routing profiles that include information indicating that agent(s) associated with the one or more routing profiles can perform the task. For example, the routing profile information may include one or more routing rules for respective routing profiles, as described in more detail elsewhere herein. The one or more routing rules may indicate permissible task types that can be routed to an agent channel associated with a given routing profile. The management device may select or determine the agent channel based on the task type being included in the permissible task types.

As another example, a routing rule may indicate one or more rules or conditions for routing tasks to the agent channel based on a current task load score associated with the routing profile. For example, the routing profile may indicate the task load score for the agent, as described elsewhere herein. The management device may determine whether the task load score satisfies a threshold (e.g., a task load threshold). The management device may determine whether to route the task to the agent channel based on whether the task load score satisfies the threshold. For example, the management device may select the agent channel for the task based on the task load score satisfying the threshold. Alternatively, the management device may refrain from selecting the agent channel for the task based on the task load score not satisfying the threshold.

In some implementations, the management device may determine an updated task load score for the agent based on the task load score (e.g., indicated by the routing profile) and one or more task attributes of the task. The updated task load score may indicate an estimated task load score for the agent if the agent were to perform the task. The management device may determine whether the updated task load score satisfies a threshold (e.g., the task load threshold). The management device may determine whether to route the task to the agent channel based on whether the updated task load score satisfies the threshold. For example, the management device may select the agent channel for the task based on the updated task load score satisfying the threshold. Alternatively, the management device may refrain from selecting the agent channel for the task based on the updated task load score not satisfying the threshold.

In some implementations, the one or more task attributes of the task may indicate a difficulty score for the task. The difficulty score may indicate a level of difficulty or complexity associated with performing the task. The routing profile may indicate that the task load score satisfies the threshold (e.g., indicating that the agent has recently performed a relatively high quantity of tasks or has recently performed one or more difficult or complex tasks). In such examples, the management device may select the agent channel based on the difficulty score of the task not satisfying a difficulty threshold (e.g., indicating that the task is relatively easy to perform or not complex). For example, if the difficulty score of the task satisfies the difficulty threshold, then the management device may refrain from selecting the agent channel for the task (e.g., because routing the task to the agent that has recently performed a relatively high quantity of tasks or has recently performed one or more difficult or complex tasks may result in inefficient performance of the task). For example, the management device may select the agent channel based on the task load score satisfying the task load threshold and based on the difficulty score not satisfying the difficulty threshold.

As an example, a task having a difficulty score that does not satisfy the difficulty threshold may be a work break task or a service-based task for the contact center network (e.g., a training task or a non-user-facing task). A work break task may have a difficulty score of zero. A work break task may indicate that the agent is to refrain from performing tasks for a given amount of time (e.g., indicating that the agent is to take a break from performing contact center tasks). For example, if the task load score of the routing profile is high (e.g., if the task load score satisfies one or more thresholds), then the management device may route or assign a work break task to the agent channel associated with the routing profile. This may improve the efficiency of tasks performed via the agent channel because the likelihood of the agent becoming overworked may be reduced.

In some implementations, the routing profile may indicate a cognitive switching limit indicative of one or more permissible task types for the agent channel. The cognitive switching limit may indicate a quantity of task types or a given one or more permissible task types that can be routed to the agent channel (e.g., over a given time period). For example, the routing profile may indicate that the agent is capable of performing a set of task types. The one or more permissible task types may be a subset of task types from the set of task types. The management device may use the cognitive switching limit to reduce the amount of task types that a given agent needs to switch between in a given time period. This may improve the performance efficiency of tasks routed to the agent channel of the agent. For example, the management device may select the agent channel based on the task type being included in the one or more permissible task types.

As another example, the management device may select the agent channel based on whether routing the task to the agent channel will result in a quantity of task types routed to the agent channel over a given time period satisfying a threshold indicated by the cognitive switching limit. For example, if routing the task to the agent channel will result in the quantity of task types satisfying the threshold, then the management device may refrain from selecting the agent channel. Alternatively, if routing the task to the agent channel will result in the quantity of task types not satisfying the threshold, then the management device may select the agent channel.

As shown in FIG. 1C, the management device may route the task to the agent channel (e.g., the selected agent channel). For example, the management device may transfer, from the network queue, the task to the agent channel. For example, as shown by reference number 135, the management device may route the tasks to a queue (e.g., an agent queue) associated with the agent channel. Routing or transferring the tasks to the agent queue may cause one or more components or systems to indicate to the agent device that the task is available for the agent to perform.

For example, as shown by reference number 140, the management device may provide, and the agent device may obtain, an indication or information associated with the task. As shown by reference number 145, the agent device may display information indicative of the task. For example, an agent user interface may display information that enables the agent to perform the task. The agent may use the agent device to perform the task.

As shown by reference number 150, the agent device may provide, and the management device may obtain, result information for the task. The result information may indicate a result or other information associated with the performance of the task. For example, the result information may include an amount of time associated with performing the task, a customer satisfaction score, an indication of whether a call or communication was resolved, a net promoter score, a wait time associated with the task, and/or other result information.

In some implementations, the task may be a machine learning feedback task for an evaluation of a machine learning output from a machine learning model. For example, the machine learning output may be associated with a contact center task. The machine learning model may be trained to evaluate or obtain information associated with the contact center task. For example, the machine learning output may indicate a tone or sentiment of a caller. The machine learning feedback task may be associated with a reinforcement learning operation of the machine learning model. For example, the machine learning feedback task may indicate that the agent is to review an input to the machine learning model (e.g., a historical task or communication) and evaluate the machine learning output. In such examples, the result information may include the evaluation of the machine learning output. For example, the management device may obtain, via the agent channel, an indication of the evaluation of the machine learning output that is input by the agent.

By the management device providing agents of the contact center with machine learning feedback tasks, the performance of the reinforcement learning operation may be improved, because the agents of the contact center may provide more accurate or insightful evaluations of contact center tasks for which the agents are trained to perform and/or experienced in performing. Additionally, the machine learning feedback tasks may have a relatively low difficulty score. Therefore, the management device may route a machine learning feedback task to an agent having a relatively high task load score, thereby providing the agent with a relatively easy task interspersed with other contact center tasks. This may improve the performance efficiency of the contact center tasks by reducing the likelihood of the agent becoming overworked and/or improve the performance of the machine learning model.

As shown by reference number 155, the management device may perform one or more actions based on the result information. For example, the management device may store the result information in one or more data storage locations, such as a data lake or database. In some implementations, the management device may provide, to a client device, the result information to enable the client device to display analytic information associated with the contact center.

In the example where the result information includes the evaluation of the machine learning output, the management device may provide or generate training information for the machine learning model. The management device may provide the training information to a device or system that trains the machine learning model. In some implementations, the management device may train the machine learning model using the evaluation of the machine learning output provided by the agent.

In some implementations, the management device may update or modify the routing profile of the agent based on the result information. In some implementations, the management device may determine updated routing profile information based on the result information. For example, the result information may indicate an actual difficulty score of the task. The management device may update or determine a new task load score for the routing profile based on the result information (e.g., based on the actual difficulty score of the task). The management device may determine one or more dynamic routing rules for the routing profile based on the new task load score, in a similar manner as described elsewhere herein. In this way, the management device may ensure that tasks are routed to the agent in accordance with dynamic network activity and a real-time workload of the agent.

As indicated above, FIGS. 1A-1C are provided as an example. Other examples may differ from what is described with regard to FIGS. 1A-1C.

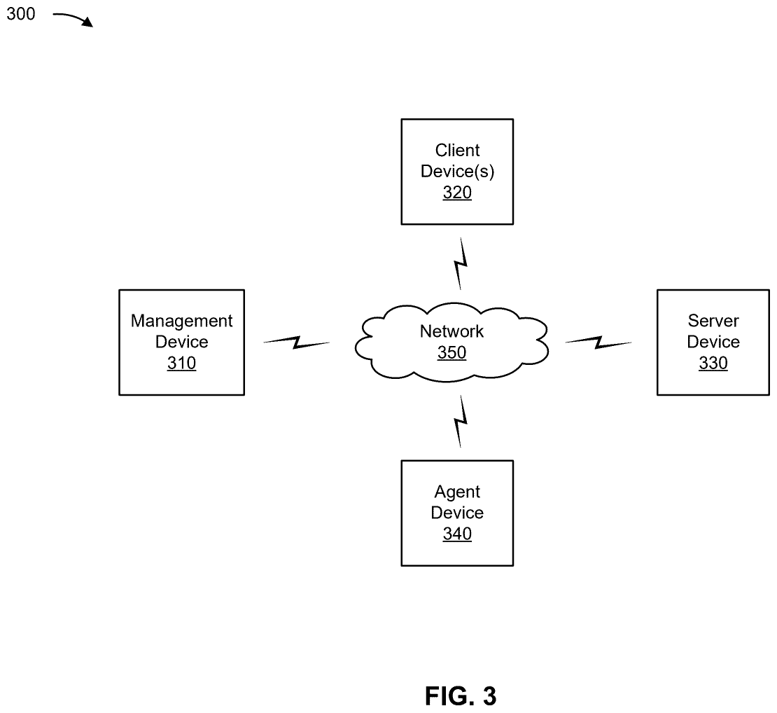

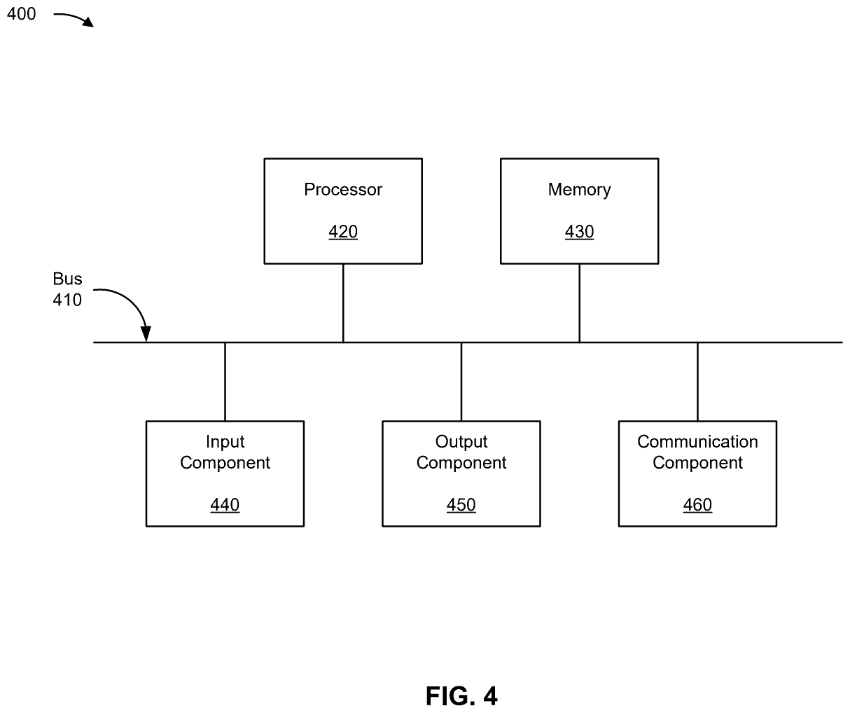

FIG. 2 is a diagram of an example associated with task management and routing in a multi-channel environment. For example, FIG. 2 depicts a system 200 configured to perform task management and routing in a multi-channel environment as described in more detail elsewhere herein, such as in connection with FIGS. 1A-1C. As shown in FIG. 2, the system 200 includes agent work 205, a network routing management component 210, a dynamic routing profile component 215, and an agent console 220 (e.g., an agent console component). These devices are described in more detail below in connection with FIG. 3 and FIG. 4.

The system 200 may obtain tasks associated with a contact center via the agent work 205. As shown in FIG. 2, the agent work 205 may include tasks having different task types, shown in FIG. 2 as task type 1 through task type N. As shown by reference number 225, a task may be provided to the network routing management component 210 for prioritization and routing.

For example, as shown by reference number 230, the network routing management component 210 may be configured to obtain an indication of one or more network conditions associated with the contact center network. As shown by reference number 235, the network routing management component 210 may be configured to obtain an indication of one or more rules (e.g., prioritization rules) for prioritizing tasks, as described in more detail elsewhere herein. In some implementations, the one or more rules may be indicated or configured via a prioritization model 240. The prioritization model 240 may be an artificial intelligence and/or machine learning model. The prioritization model 240 may be configured to output prioritization rules for prioritizing tasks for the system 200. The prioritization model 240 may use the one or more network conditions and routing profile information as an input. An output of the prioritization model 240 may be indicative of the one or more rules (e.g., prioritization rules).

As shown by reference number 245, the network routing management component 210 may be configured to obtain routing profile information and/or updated routing profile information. The routing profile information is described in more detail in connection with FIGS. 1A-1C. The dynamic routing profile component 215 may determine the routing profile information in a similar manner as described herein, such as in connection with reference number 115. For example, the dynamic routing profile component 215 may determine the routing profile information using agent data (e.g., agent preference information or previous tasks performed by one or more agents), one or more routing rules (e.g., defined via input(s) from a rules user interface (UI) 250), and/or an output of a rules model 255 (e.g., the routing and/or rule optimization model), among other examples.

The network routing management component 210 may include a queuing engine configured to queue tasks in the network queue, as described in more detail elsewhere herein. For example, as shown by reference number 260, the queuing engine may prioritize the task by queuing the task in the network queue in a similar manner as described elsewhere herein, such as in connection with reference number 125. The network routing management component 210 may include a routing engine configured to select an agent channel via which the task is to be routed. For example, as shown by reference number 265, the routing engine may select an agent channel for the task as described in more detail elsewhere herein, such as in connection with reference number 130.

As shown by reference number 270, the network routing management component 210 may route the task to the agent console 220. For example, the network routing management component 210 may route the task to an agent queue associated with the selected agent channel. The task may be provided from the agent queue to an agent user interface system. As shown by reference number 275, an agent may perform the task via the agent user interface system.

In some implementations, the system may include a feedback component (not shown in FIG. 2). The feedback component may be configured to perform one or more actions based on result information of performed tasks, in a similar manner as described in connection with reference number 155.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

FIG. 3 is a diagram of an example environment 300 in which systems and/or methods described herein may be implemented. As shown in FIG. 3, environment 300 may include a management device 310, one or more client devices 320, a server device 330, an agent device 340, and a network 350. Devices of environment 300 may interconnect via wired connections, wireless connections, or a combination of wired and wireless connections.

The management device 310 may include one or more devices capable of receiving, generating, storing, processing, providing, and/or routing information associated with task management and routing in a multi-channel environment, as described elsewhere herein. The management device 310 may include a communication device and/or a computing device. For example, the management device 310 may include a server, such as an application server, a client server, a web server, a database server, a host server, a proxy server, a virtual server (e.g., executing on computing hardware), or a server in a cloud computing system. In some implementations, the management device 310 may include computing hardware used in a cloud computing environment. In some implementations, the management device 310 may include one or more components or elements depicted and described in connection with FIG. 2, such as the network routing management component, the dynamic routing profile component, and/or the agent console.

A client device 320 may include one or more devices capable of receiving, generating, storing, processing, and/or providing information associated with task management and routing in a multi-channel environment, as described elsewhere herein. The client device 320 may include a communication device and/or a computing device. For example, the client device 320 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The server device 330 may include one or more devices capable of receiving, generating, storing, processing, providing, and/or routing information associated with task management and routing in a multi-channel environment, as described elsewhere herein. The server device 330 may include a communication device and/or a computing device. For example, the server device 330 may include a server, such as an application server, a client server, a web server, a database server, a host server, a proxy server, a virtual server (e.g., executing on computing hardware), or a server in a cloud computing system. In some implementations, the server device 330 may include computing hardware used in a cloud computing environment.

The agent device 340 may include one or more devices capable of receiving, generating, storing, processing, and/or providing information associated with task management and routing in a multi-channel environment, as described elsewhere herein. The agent device 340 may include a communication device and/or a computing device. For example, the agent device 340 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device. In some implementations, the agent device may include, or may be associated with, the agent console depicted and described in connection with FIG. 2.

The network 350 may include one or more wired and/or wireless networks. For example, the network 350 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 350 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with task management and routing in a multi-channel environment. The device 400 may correspond to the management device 310, a client device 320, the server device 330, the agent device 340, the system 200, the network routing management component 210, the dynamic routing profile component 215, and/or the agent console 220. In some implementations, the management device 310, a client device 320, the server device 330, the agent device 340, the system 200, the network routing management component 210, the dynamic routing profile component 215, and/or the agent console 220 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection).

The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

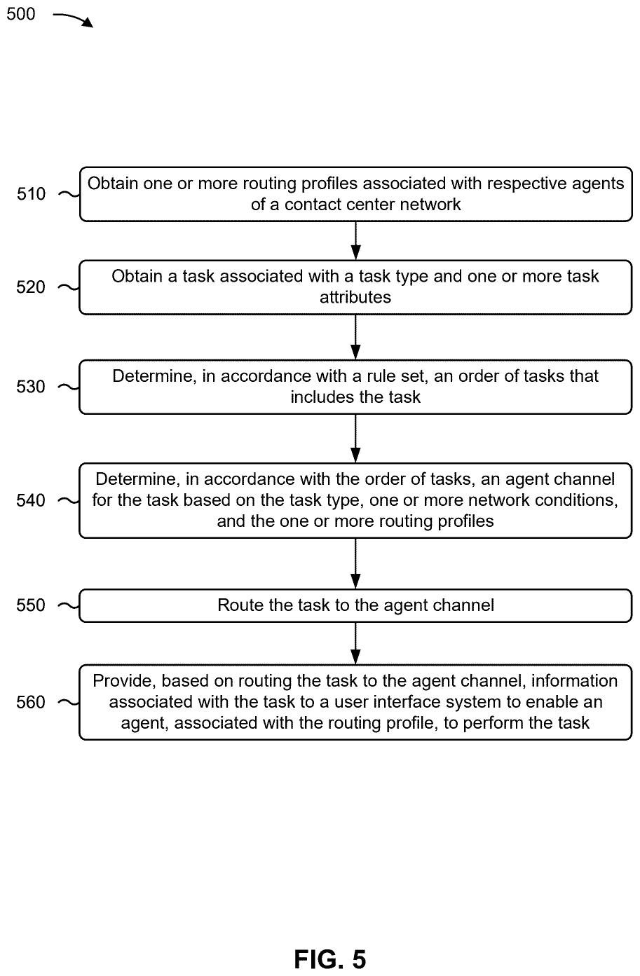

FIG. 5 is a flowchart of an example process 500 associated with task management and routing in a multi-channel environment. In some implementations, one or more process blocks of FIG. 5 may be performed by the management device 310. In some implementations, one or more process blocks of FIG. 5 may be performed by another device or a group of devices separate from or including the management device 310, such as the client device(s) 320, the server device 330, and/or the agent device 340. Additionally, or alternatively, one or more process blocks of FIG. 5 may be performed by one or more components of the device 400, such as processor 420, memory 430, input component 440, output component 450, and/or communication component 460. Additionally, or alternatively, one or more process blocks of FIG. 5 may be performed by one or more components of the system 200, such as the network routing management component 210, the dynamic routing profile component 215, and/or the agent console 220.

As shown in FIG. 5, process 500 may include obtaining one or more routing profiles associated with respective agents of a contact center network (block 510). For example, the management device 310 (e.g., using processor 420 and/or memory 430) may obtain one or more routing profiles associated with respective agents of a contact center network, as described above in connection with reference number 115 of FIG. 1A. As an example, a routing profile may indicate dynamic information for routing tasks to a particular agent of the contact center network, such as a task load score (e.g., indicating a level or workload of the agent).

As further shown in FIG. 5, process 500 may include obtaining a task associated with a task type and one or more task attributes (block 520). For example, the management device 310 (e.g., using processor 420 and/or memory 430) may obtain a task associated with a task type and one or more task attributes, as described above in connection with reference number 120 of FIG. 1B. As an example, the task may be a task to be performed by an agent of the contact center network.

As further shown in FIG. 5, process 500 may include determining an order of tasks that includes the task (block 530). For example, the management device 310 (e.g., using processor 420 and/or memory 430) may determine an order of tasks that includes the task, as described above in connection with reference number 125 of FIG. 1B. In some implementations, the rule set includes one or more intra-task-type rules associated with the task type and one or more inter-task-type rules associated with multiple task channels. As an example, the management device 310 may prioritize the task within a network queue. For example, the order of the tasks may be an order of the tasks within the network queue.

As further shown in FIG. 5, process 500 may include determining an agent channel for the task based on the task type, one or more network conditions, and the one or more routing profiles (block 540). For example, the management device 310 (e.g., using processor 420 and/or memory 430) may determine an agent channel for the task based on the task type, one or more network conditions, and the one or more routing profiles, as described above in connection with reference number 130 of FIG. 1B. In some implementations, the agent channel is associated with a routing profile, of the one or more routing profiles, based on current task load information of the routing profile and the one or more task attributes. As an example, the management device 310 may select the agent channel based on the task type, one or more network conditions, and the routing profile associated with the agent channel.

As further shown in FIG. 5, process 500 may include routing the task to the agent channel (block 550). For example, the management device 310 (e.g., using processor 420 and/or memory 430) may route the task to the agent channel, as described above in connection with reference number 135 of FIG. 1C. As an example, the management device 310 may transfer the task from the network queue to an agent queue.

As further shown in FIG. 5, process 500 may include providing, based on routing the task to the agent channel, information associated with the task to a user interface system to enable an agent, associated with the routing profile, to perform the task (block 560). For example, the management device 310 (e.g., using processor 420 and/or memory 430) may provide, based on routing the task to the agent channel, information associated with the task to a user interface system to enable an agent, associated with the routing profile, to perform the task, as described above in connection with reference number 140 of FIG. 1C.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1C and/or 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for task management and routing for a contact center network, the system comprising:
a dynamic routing profile component, configured to:
obtain one or more routing rules associated with one or more routing profiles, wherein the one or more routing profiles are associated with respective agents;
determine, based on dynamic network activity of the contact center network and the one or more routing rules, routing profile information for respective routing profiles of the one or more routing profiles; and
provide, to a network routing management component, the routing profile information;
the network routing management component, configured to:
obtain an indication of one or more network conditions associated with the contact center network;
obtain an indication of a task associated with the contact center network, wherein the task is associated with a task type and one or more task attributes;
assign, for the task, a position in a network queue, wherein the position is based on one or more rules and the one or more network conditions, and wherein the network queue includes tasks associated with multiple task types;
select, for the task, an agent channel that is associated with an agent of the contact center network based on the routing profile information, the task type, and the one or more task attributes; and
transfer, from the network queue, the task to the agent channel.

2. The system of claim 1, further comprising an agent console component, configured to:
provide, from the agent channel, information indicative of the task for display via a user interface system.

3. The system of claim 1, wherein the agent channel is associated with a routing profile of the one or more routing profiles, wherein the one or more task attributes indicate that a difficulty score for the task does not satisfy a difficulty threshold, wherein the routing profile information indicates that a task load score associated with the routing profile satisfies a task load threshold, and wherein the network routing management component, to select the agent channel, is configured to:
select the agent channel based on the task load score satisfying the task load threshold and based on the difficulty score not satisfying the difficulty threshold.

4. The system of claim 3, wherein the task type is a work break.

5. The system of claim 3, wherein the task load score is based on one or more previous tasks performed by the agent as indicated by the dynamic network activity.

6. The system of claim 1, wherein the one or more rules are prioritization rules for prioritizing tasks in the network queue, and wherein the one or more rules include one or more intra-task-type rules associated with the task type and one or more inter-task-type rules associated with the multiple task types.

7. The system of claim 1, wherein the task is a machine learning feedback task for an evaluation of a machine learning output from a machine learning model, and wherein the machine learning output is associated with a contact center task.

8. The system of claim 7, further comprising a feedback component configured to:
obtain, via the agent channel, an indication of the evaluation of the machine learning output, wherein the evaluation is input by the agent; and
provide the evaluation to cause the machine learning model to be trained based on the evaluation.

9. The system of claim 1, wherein the dynamic routing profile component is further configured to:
obtain agent preference information associated with one or more agents including the agent; and
wherein the routing profile information is based on the agent preference information.

10. The system of claim 1, wherein the agent channel is associated with a routing profile of the one or more routing profiles, wherein the routing profile indicates a cognitive switching limit indicative of one or more permissible task types for the agent channel, and wherein the network routing management component, to select the agent channel, is configured to:
select the agent channel based on the task type being included in the one or more permissible task types.

11. The system of claim 1, wherein the dynamic routing profile component is further configured to:
obtain result information indicative of a result of the task as performed by the agent;
update, based on the result information, the routing profile information to updated routing profile information; and
provide, to the network routing management component, the updated routing profile information.

12. The system of claim 1, wherein the dynamic routing profile component, to determine the routing profile information, is configured to:
provide, to a machine learning model, the dynamic network activity, the one or more routing rules, and agent preference information; and
obtain, via an output of the machine learning model, the routing profile information.

13. A method for task management and routing, comprising:
obtaining, by a device, one or more routing profiles associated with respective agents of a contact center network;
obtaining, by the device, a task associated with a task type and one or more task attributes;
determining, by the device in accordance with a rule set, an order of tasks that includes the task, wherein the rule set includes one or more intra-task-type rules associated with the task type and one or more inter-task-type rules associated with multiple task channels;
determining, by the device in accordance with the order of tasks, an agent channel for the task based on the task type, one or more network conditions, and the one or more routing profiles,
wherein the agent channel is associated with a routing profile, of the one or more routing profiles, based on current task load information of the routing profile and the one or more task attributes;
routing, by the device, the task to the agent channel; and
providing, by the device and based on routing the task to the agent channel, information associated with the task to a user interface system to enable an agent, associated with the routing profile, to perform the task.

14. The method of claim 13, wherein the one or more task attributes indicate that a difficulty score for the task does not satisfy a difficulty threshold, wherein the routing profile indicates that a task load score associated with the routing profile satisfies a task load threshold, and wherein determining the agent channel comprises:
selecting the agent channel for the task based on the task load score satisfying the task load threshold and based on the difficulty score not satisfying the difficulty threshold.

15. The method of claim 13, wherein the rule set includes one or more prioritization rules for prioritizing tasks associated with the multiple task channels.

16. The method of claim 13, further comprising:
obtaining result information indicative of a result of the task as performed by the agent; and
updating, based on the result information, the routing profile to updated routing profile.

17. A system for task management and routing, the system comprising:
one or more memories; and
one or more processors, communicatively coupled to the one or more memories, configured to:
obtain one or more routing rules associated with one or more routing profiles, wherein the one or more routing profiles are associated with respective agents;
determine, based on dynamic network activity of a contact center network and the one or more routing rules, routing profile information for respective routing profiles of the one or more routing profiles; and
obtain an indication of a task associated with the contact center network, wherein the task is associated with a task type and one or more task attributes;
assign, for the task, a position in a network queue, wherein the position is based on one or more rules and one or more network conditions, and wherein the network queue includes tasks associated with multiple task types;
select, for the task, an agent channel that is associated with an agent of the contact center network based on the routing profile information, the task type, and the one or more task attributes;
transfer, from the network queue, the task to the agent channel; and
provide, from the agent channel, information indicative of the task for display via a user interface system.

18. The system of claim 17, wherein the agent channel is associated with a routing profile of the one or more routing profiles, wherein the one or more task attributes indicate that a difficulty score for the task does not satisfy a difficulty threshold, wherein the routing profile information indicates that a task load score associated with the routing profile satisfies a task load threshold, and wherein the one or more processors, to select the agent channel, are configured to:
select the agent channel based on the task load score satisfying the task load threshold and based on the difficulty score not satisfying the difficulty threshold.

19. The system of claim 18, wherein the task type is a service-based task or a non-user-facing task for the contact center network.

20. The system of claim 17, wherein the one or more rules are prioritization rules for prioritizing tasks in the network queue, and wherein the one or more rules include one or more intra-task-type rules associated with the task type and one or more inter-task-type rules associated with the multiple task types.
